(19) United States
(12) Patent Application Publication
(10) Pub. No.: US 2021/0289602 A1
(43) Pub. Date: Sep. 16, 2021

(54) A MANS-POWERED DEVICE AND DRIVE METHOD

(71) Applicant: SIGNIFY HOLDING B.V., EINDHOVEN (NL)

(72) Inventors: ETIENNE NICOLAAS EBERSON, ECHT (NL); PIETER DE HAAN, VUGHT (NL)

(21) Appl. No.: 16/338,742

(22) PCT Filed: Sep. 26, 2017
(86) PCT No.: PCT/EP2017/074311

§ 371 Date: Apr. 2, 2019

(30) Foreign Application Priority Data
Oct. 4, 2016 (EP) 16192140.8

(51) Int. Cl. H05B 45/50; H02H 11/00; H05B 41/36

(52) U.S. Cl. CPC H05B 45/50; H05B 41/36; H02H 11/006

(57) ABSTRACT

A mains-powered module and a driving method are provided, in which the voltage and/or frequency of received mains power is detected. A disabling circuit is used to disable a driver circuit if the mains power profile characteristics do not match those for which the module has been designed.

### FIELD OF THE INVENTION

This invention relates to mains-powered devices, such as mains-powered lighting.

### BACKGROUND OF THE INVENTION

Different countries around the world have different mains voltages and frequencies. There are also other standards which differ between different countries or regions.

For example, a nominal voltage of 220V to 230 V and a frequency of 50 Hz is used in Europe, most of Africa, most of Asia, most of South America and Australia. In North America, the most common combination is 120 V and a frequency of 60 Hz. There is also a 277V supply in the US used for industrial scale lighting.

Thus, a lamp for the European market, for example, has a different set of standards which have to be met compared to a lamp for the US market, and a different range of possible mains input voltages and frequencies.

In order to gain the greatest benefit from economies of scale of mass produced items, such as mains-powered lamps, it is often desired to provide designs which are compatible with multiple standards, thus creating a universal design. However, this generally requires additional circuitry, for example to enable a wide range of mains input voltages and a range of mains frequencies to be tolerated.

If a most cost-effective design is desired, it becomes very difficult to comply with all requirements to enable a universal design and still maintain keep a sufficiently low price for the driver circuitry, despite the economies of scale associated with mass production.

Therefore, in some designs, it is necessary to sacrifice the universal functionality in order to achieve the lowest cost possible. For example, to reduce the costs of an EMI (electromagnetic interference) filter and lamp driver input stage in Europe, dedicated US and European versions of the lamp may be made, in order to provide the lowest cost for the European version with lower EMI filtering requirements, for example.

The US version requires (i.e. can accept) a mains input of 120V or 277V at 60 Hz whereas the European version requires (i.e. can accept) a mains input of 220-240V at 50 Hz. Products can be clearly marked to indicate the nature of the mains signal for which the product meets the required standards and hence can operate safely.

Since the European version is likely to be lower cost than the US version, there will be a tendency for customers to order European types to be operated on a 277V 60 Hz mains system in the US.

The European product will however not comply with the applicable standards in the US. Similarly, the US version of the product will not meet European standards.

A European (220-240V and 50 Hz) design when operated at 277 V and 60 Hz may still function, but may result in EMI problems. However, more serious is that this may create a fire-hazard.

There is therefore a need for a system which ensures that low cost (non-universal) mains lighting modules are only used in the appropriate geographical regions where the applicable design standards have been met.

### SUMMARY OF THE INVENTION

The invention is defined by the claims.

According to examples in accordance with an aspect of the invention, there is provided a mains-powered module for driving a load, comprising:

an input for receiving mains power;

a detection circuit for detecting the voltage and/or frequency of the mains power, thereby to determine a mains power profile wherein the determined mains power profile corresponds to a geographical region wherein the module is used;

a driver circuit for driving the load, the driver circuit being adapted for use with a particular mains power profile which corresponds to a geographical region for which the driver is adapted to be used; and

a disabling circuit for disabling the driver circuit if the determined mains power profile does not match the particular mains power profile.

The invention enables specific, cost-effective designs for dedicated geographical regions, each having a particular mains power profile. The module disables its function when an inappropriate mains supply is detected. When the module is not working, the end-user will remove the load and any hazardous situation is prevented.

The load is for example a lighting element, and the module is a lighting module.

The mains power profile may simply be a voltage or a frequency or else a combination of both.

The determined mains power profile and the particular mains power profile for example each correspond to a geographical region, such that the detection circuit detects a geographical region in which the module is used, and the driver circuit is adapted for use in a particular geographical region.

As mentioned above, different geographical regions share mains power profiles. Thus, the geographical region corresponding to the “particular mains power profile” (for which the module is designed) may comprise a set of areas or countries for which a single design can be compatible at low cost. Similarly, the geographical region corresponding to the “determined mains power profile” may comprise a set of areas or countries which share the determined mains power profile characteristics. If there is overlap between the mains power profiles, it follows that the module is being used in an area with which the design is compatible, from a standards viewpoint.

Thus, the module is preferably compatible with the standards associated with the geographical region corresponding to the “particular mains power profile”.

The particular geographical region for example comprises the US or Europe.

Thus, there may be one design for the US (and other regions with which the US design is compatible) and another design for Europe (and other regions with which the European design is compatible).

The determined geographical region thus also comprises the US (or other areas with equivalent mains power profile) or Europe (or other areas with equivalent mains power profile).

The detection circuit may comprise a frequency detector. This needs to discriminate between 50 Hz (Europe) and 60 Hz (US).

For example, a detected frequency below 55 Hz is a first determined mains power profile which corresponds to a first geographical region which includes Europe, and a detected frequency above 55 Hz is a second determined mains power profile which correspond to a second geographical region which includes the US.

The detection circuit may comprise a voltage detector. This needs to discriminate between 120 V or 277V (US) and 220-240V (Europe).

For example, a detected voltage between a first threshold which is greater than 120V and a second threshold which is below 277V is a first determined mains power profile which corresponds to a first geographical region which includes Europe and a detected voltage outside the range is a second determined mains power profile which corresponds to a second geographical region which includes the US. The first threshold could be any value between 120V and 220V simply to distinguish between a voltage of 120V or below and a voltage of 220V or above. The first threshold may for example be 150V. The second threshold is to distinguish between a voltage of around 240V one at 277V The second threshold may for example be 270V.

The disabling circuit for example comprises a processor. This is for example used to send a software-generated interrupt to the driver circuit. Alternatively, an analog circuit may be used.

The driver circuit for example comprises an EMI filter, a rectifier, and a driver output stage. A single stage driver may be used, or else there may be a separate power factor correction circuit and driver output stage.

The module for example comprises a high intensity discharge lamp, or an LED arrangement.

Examples in accordance with another aspect of the invention provide a method of controlling a mains-powered module, comprising:

receiving mains power;

detecting the voltage and/or frequency of the mains power, thereby to determine a mains power profile wherein the determined mains power profile corresponds to a geographical region wherein the module is used;

controlling a driver circuit which is adapted for use with a particular mains power profile, which corresponds to a geographical region for which the driver is adapted to be used, by:
powering a load if the determined mains power profile matches the particular mains power profile; and
disabling the driver circuit if the determined mains power profile does not match the particular mains power profile.

This method actively disables a module when it is being used with a mains power profile for which it has not been designed, and therefore does not necessarily meet local standards.

The determined mains power profile and the particular mains power profile for example each correspond to a geographical region, such that the detection circuit detects a geographical region in which the module is used, and the driver circuit is adapted for use in a particular geographical region.

The method may comprise detecting a frequency below 55 Hz as a first determined mains power profile which corresponds to a first geographical region which includes Europe, and detecting a frequency above 55 Hz as a second determined mains power profile which correspond to a second geographical region which includes the US.

Alternatively or additionally, the method may comprise detecting a voltage which is in a range from a first threshold which is greater than 120V to a second threshold which is below 277V as a first determined mains power profile which corresponds to a first geographical region which includes Europe and detecting a voltage outside the range as a second determined mains power profile which corresponds to a second geographical region which includes the US.

### BRIEF DESCRIPTION OF THE DRAWINGS

Examples of the invention will now be described in detail with reference to the accompanying drawings, in which:

FIG. 1 shows a lighting module; and

FIG. 2 shows a method of driving a lighting module.

### DETAILED DESCRIPTION OF THE EMBODIMENTS

The invention provides a mains-powered module and a driving method, in which the voltage and/or frequency of received mains power is detected. A disabling circuit is used to disable a driver circuit if the mains power profile characteristics do not match those for which the module has been designed. The invention is of particular interest for lighting modules, although it can be applied to other mains-powered modules.

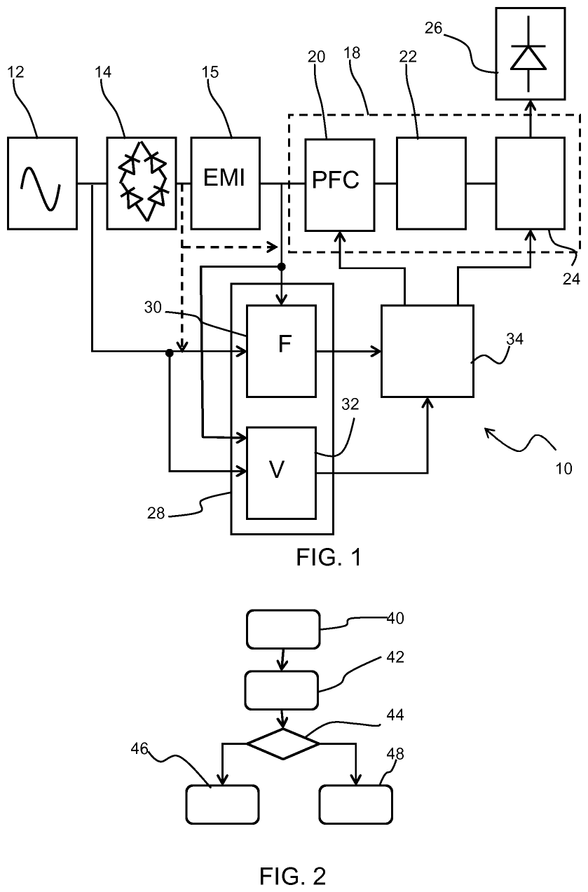

FIG. 1 shows a lighting system 10 which is powered by a mains supply 12. The lighting system comprises a rectifier 14 and EMI filtering stage 16. The rectified and filtered mains is provided to a lighting driver circuit 18. In the example shown, the driver comprises a power factor correction (PFC) stage 20, a buffer 22 and an output stage 24. The PFC stage is optional, or it could instead be integrated into a single stage driver. The output stage 24 drives a load in the form of a lighting element 26 such as a high intensity discharge lamp, an LED or an LED arrangement.

The driver circuit 18 is adapted for use with a particular mains power profile, such as a particular frequency and/or range of voltages. The mains power profile corresponds to a geographical region, such as Europe (and other regions with equivalent supply) or the US (and other regions with equivalent supply).

The other parts of the driver are also adapted for use with the particular mains profile. For example, standards associated with the different regions may dictate the use of different types of filtering and/or rectification, or indeed other aspects of the overall product design.

The system further comprises a detection circuit 28. In the example shown, there is a frequency detector 30 and a voltage detector 32.

The frequency detector 30 analyzes the mains input and/or the rectified mains signal in order to determine the frequency. It may operate with a threshold of between 50 Hz and 60 Hz so that 50 Hz regions can be distinguished from 60 Hz regions. For example, below 55 Hz is interpreted as a first determined mains power profile which corresponds to a first geographical region which includes Europe, and above 55 Hz is interpreted as a second determined mains power profile which correspond to a second geographical region which includes the US.

The voltage detector 32 also may analyze the mains input and/or the rectified mains signal in order to determine the mains voltage. A detected voltage in the range 120V to 277V is interpreted as a first determined mains power profile which corresponds to a first geographical region which includes Europe and a detected voltage outside the range is interpreted as a second determined mains power profile which corresponds to a second geographical region which includes the US. Thus, a voltage of 120V (or below) or 277V (or above) is interpreted as a US system voltage whereas a voltage between, e.g. close to 230V, is interpreted as a European system.

The voltage detection may be based on a first lower threshold, and a second higher threshold, together defining a voltage range. The thresholds are for example 150V and 270V so that the range 150V to 270V is for the European region, whereas below 150V or above 270V is for the US region.

The detection may instead take place after rectification but before filtering (shown as dotted lines in FIG. 1).

Note that the voltage levels are root mean square voltage values.

The system is in this way able to detect if it is being used in an area having a mains power profile for which it was designed (which is termed the “particular mains profile”). The system has a disabling circuit 34 for disabling the driver circuit 18 if the determined mains power profile does not match the particular mains power profile. The disabling circuit may be a digital processor or an analogue circuit.

In this way, region-specific, low cost module designs may be used, each for a dedicated geographical region (which may be a set of countries, for example), having a particular common mains power profile. The module disables its function when an inappropriate mains supply is detected. There may be one design for the US (and other regions with which the US design is compatible such as Canada) and another design for Europe (and other regions with which the European design is compatible). However, there may be more than two product designs so that more geographical regions may be covered, such as Japan.

The determined geographical region thus also comprises the US (or other areas with equivalent mains power profile) or Europe (or other areas with equivalent mains power profile).

The disabling circuit 34 for example comprises a processor which performs an enable or disable function. For example, it controls the operation of the PFC stage and/or the driver output stage.

It may interface with any part of the circuitry in order to prevent operation of the lighting element 26 but remain in a safe condition. There may be a dedicated disable switch in addition to the normal driver circuitry, or the disabling circuit may interface with the normal driver circuitry.

FIG. 2 shows a method of controlling a mains-powered lighting module. In step 40, mains power is received. In step 42, the voltage and/or frequency of the mains power is detected, thereby to determine a mains power profile.

In step 44 it is determined whether or not the determined mains power profile matches a particular mains power profile for which the lighting module is designed.

In step 46 a current is driven through a lighting element of the module if the determined mains power profile matches the particular mains power profile.

In step 48 the driver circuit is disabled if the determined mains power profile does not match the particular mains power profile.

This method actively disables a module when it is being used with a mains power profile for which it has not been designed, and therefore does not necessarily meet local standards.

As mentioned above, the detection of the mains power profile may be based on voltage measurement or frequency measurement or both.

Circuitry for implementing the required detection is well known, for example within universal mains devices, which instead control the circuit operation in dependence on the detected mains power profile.

Frequency detection can be performed based on detecting zero crossings of the mains voltage and by measuring the time difference between two consecutive zero-crossing. Other frequency detection methods are available, for example by using band pass filters or low pass and high pass filters. Frequency detection based on a current flowing through a reactive component is also possible

A comparator with a known reference voltage can be used for voltage detection, based on expected ranges of voltages to be received in different systems.

The idea may be used in any lamp design and is not limited to high intensity discharge lamps or to LED technology.

Furthermore, the invention is not limited to lighting modules. Any low-cost mass produced module may have different versions for different regions. An example is a mobile phone charger, for which the mobile phone functions as the load. There are of course many other examples of power adaptor (i.e. mains to DC converters) which may be disabled when not connected to the appropriate supply.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A mains-powered module for driving a load, comprising:
an input for receiving mains power;
a detection circuit for detecting the voltage and frequency of the mains power, thereby to determine a mains power profile wherein the determined mains power profile corresponds to a geographical region wherein the module is used;
a driver circuit for driving the load, the driver circuit being adapted for use with a particular mains power profile which corresponds to a geographical region for which the driver is adapted to be used; and
a disabling circuit for disabling the driver circuit if the determined mains power profile does not match the particular mains power profile.

2. A module as claimed in claim 1, comprising the load, wherein the load comprises a lighting element such as a high intensity discharge lamp or an LED arrangement, and the mains-powered module is a lighting module.

3. A module as claimed in claim 1, wherein the particular geographical region is one from a list which comprises at least the US and Europe and the determined geographical region is one from a list which comprises at least the US or Europe.

4. A module as claimed in claim 1, wherein the detection circuit comprises a frequency detector.

5. A module as claimed in claim 4, wherein a detected frequency below 55 Hz is a first determined mains power profile which corresponds to a first geographical region which includes Europe, and a detected frequency above 55 Hz is a second determined mains power profile which correspond to a second geographical region which includes the US.

6. A module as claimed in claim 1, wherein the detection circuit comprises a voltage detector.

7. A module as claimed in claim 6, wherein a detected voltage in the range from a first threshold which is greater than 120V to a second threshold which is below 277V is a first determined mains power profile which corresponds to a first geographical region which includes Europe and a detected voltage outside the range is a second determined mains power profile which corresponds to a second geographical region which includes the US.

8. A module as claimed in claim 1, wherein the disabling circuit comprises a processor or an analog circuit.

9. A module as claimed in claim 1, wherein the driver circuit comprises an EMI filter, a rectifier, and a driver output stage.

10. A method of controlling a mains-powered module, comprising:
receiving mains power;
detecting the voltage and frequency of the mains power, thereby to determine a mains power profile wherein the determined mains power profile corresponds to a geographical region wherein the module is used;
controlling a driver circuit which is adapted for use with a particular mains power profile, which corresponds to a geographical region for which the driver is adapted to be used, by:
powering a load if the determined mains power profile matches the particular mains power profile; and
disabling the driver circuit if the determined mains power profile does not match the particular mains power profile.

11. A method as claimed in claim 10 for controlling a mains-powered lighting module, wherein powering a load comprises driving a current through a lighting element such as a high intensity discharge lamp or an LED arrangement.

12. A method as claimed in claim 10, comprising detecting a frequency below 55 Hz as a first determined mains power profile which corresponds to a first geographical region which includes Europe, and detecting a frequency above 55 Hz as a second determined mains power profile which correspond to a second geographical region which includes the US.

13. A method as claimed in claim 10, comprising detecting a voltage which is in a range from a first threshold which is greater than 120V to a second threshold which is below 277V as a first determined mains power profile which corresponds to a first geographical region which includes Europe, and detecting a voltage outside the range as a second determined mains power profile which corresponds to a second geographical region which includes the US.
